(19) United States
(12) Patent Application Publication
(10) Pub. No.: US 2005/0193416 A1
(43) Pub. Date: Sep. 1, 2005

(54) Method of access and handling service lists

(76) Inventor: Piotr Przybylek, Zielona Gora (PL)

Correspondence Address: WILLIAM COLLARD;COLLARD & ROE, P.C., 1077 NORTHERN BOULEVARD, ROSLYN, NY, 11576, US

(21) Appl. No.: 10/657,536

(22) Filed: Sep. 8, 2003

(30) Foreign Application Priority Data
Sep. 9, 2002 (PL) P355927

(51) Int. Cl. H04N 7/173; G06F 7/00; G06F 17/30; G06F 3/00; G06F 17/00; G06F 13/00; H04N 5/445; H04N 7/16

(52) U.S. Cl. 725/53; 725/115; 725/145; 725/86; 725/52; 707/1; 707/100

(57) ABSTRACT

The method of access and handling service lists, set up earlier from such services as television and radio channels, DVD libraries, web sites, as well as user services, available in a handling device equipped at least with the functions of a decoder of digital television, while the service lists are general lists, set up by the decoder and preference lists, set up by the user. After selecting the function of moving to the next list, an identifier is fetched from storage (BOK) of the handling device (DK): of the service that has been recently viewed on the list, which is next after the one displayed during selection of this function or the first from the next list, and the handling device (DK) is set to receive this service, with parallel display, on the screen of television set, of information about the assignment of the service to the list and its viewing ratings. In the consecutive steps, a transition to the next lists occurs, while in case of defining a specific list, after selecting a function of choosing another element from this lit, at least one list of services available on this list is fetched from the storage (BOK) of the handling device (DK), and next after defining the viewing ratings for each service of this list, a list of services is displayed together with information about the assignment of this list and viewing ratings.

The object of the invention is the method of access and handling service lists, especially television and radio channels, DVD film libraries, web sites, and user services.

There are known methods of creating service lists according to various criteria: according to the source of signal, for example: cable or satellite television signal, radio signal, web site signal, other sources—for example DVD, subject lists for example sport or music, according to time criterion, for example according to the date of the most frequently watched channels or lists, the content of which is defined directly by the user, while the service lists are general lists set up by the decoder, or preference lists, set up by the user.

There are also known methods of navigating between these lists, as for example, the method of handling lists and sublists, available in the decoder of services, sorted according to the preferences of the user, presented in the American patent no. U.S. Pat. No. 6,182,287 entitled ‘Preferred service management system for a multimedia video decoder’.

However, the method of handling these lists, which is presented there, may seem too hard for certain users. It requires to select an element every time from the list before displaying it—due to this, it takes much time, especially when the user wants to view quickly his/her favorite programs in different lists. However if the full lists are to be presented on the display, they cover the viewed picture—and turning off the list display can be performed by pressing buttons in a sequence—which also may be hard at fast previewing.

The essence of the method of invention is that after selecting a function of moving to the next list an identifier is fetched from the storage of the service device. This is an identifier of the last viewed service on the list, which comes next after the one displayed at selection of this function or the first one from the next list. The equipment is set up to receive this service, displaying also, on the screen of TV set, information on its affiliation to the list and its viewing ratings, and subsequently in the next steps, a transition to the consecutive lists takes place, and in case of setting a specific list, after choosing the function of selecting another service from this list, at least one list of services, available on this list, is fetched from the storage of the handling device. Subsequently after viewing ratings are set for every element of this list, a list of services is displayed together with information about their affiliation to a list and viewing ratings.

In a favorable extension of the invention, at least two lists of services, available in this storage are taken from the storage of the handling device, and after the viewing ratings are defined for each element of separate lists, a list of services is displayed together with information about their connection with the list and viewing ratings and next using the total content of the displayed lists, the content of separate lists is being modified.

Next, it is also beneficial that the viewing ratings of a service are set as a percentage ration between its viewing ratings and viewing ratings of selected services of the fetched list.

Moreover, it is favorable that the selection of the transition to the next list, as well as the selection of the service from currently active list, and modification of the content of separate lists is made directly, by means of dedicated buttons of the remote control unit.

It is also beneficial when the displayed information about the affiliation to a list and viewing ratings of a selected service are attributed to graphical symbols.

Next, it is also favorable when the information displayed is attributed to graphical symbols in form of genre icons.

It is also beneficial that when making a choice of function of adding the currently viewed service to the list, in case this service occurs on one of inactive preference lists, it is on the list set up by the user, this list is activated, while in case the service viewed does not appear on any inactive preference lists, this service is added to the selected preference list.

Finally, it is favorable that in case of selecting a preference list as the first one, a default list is presented—the list to which an element has been added recently.

Thanks to the presented solution, according to the invention, the user—by means of pressing the remote control button once—can go to a favorite element from the next list, thanks to which he can find quickly and easily the program, which is interesting for him; this option is especially useful with fast preview of the favorite elements of separate lists. Additionally, the precisely configured information about the selected service, obtained thanks to using this method—with providing the name of the list in the area with a color, service name and its viewing ratings assigned to a given list in form of an icon with a shape that depends on the viewing ratings—are effectively presented, with use of just a small fragment of the display.

Example. To Present an example of the method, according to the invention, a drawing was used as a support, and its separate figures present the following:

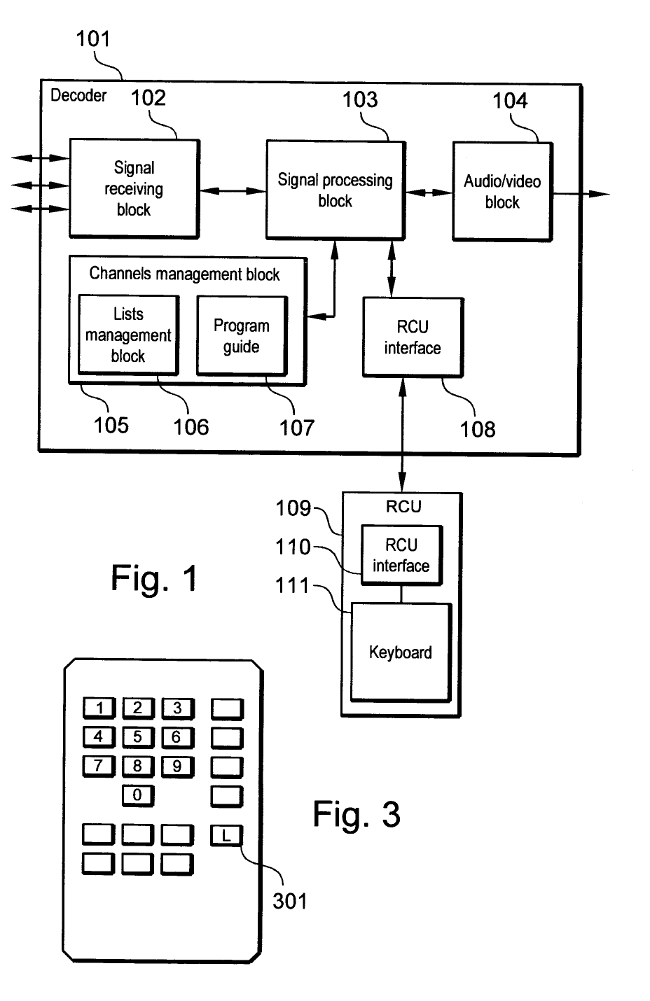

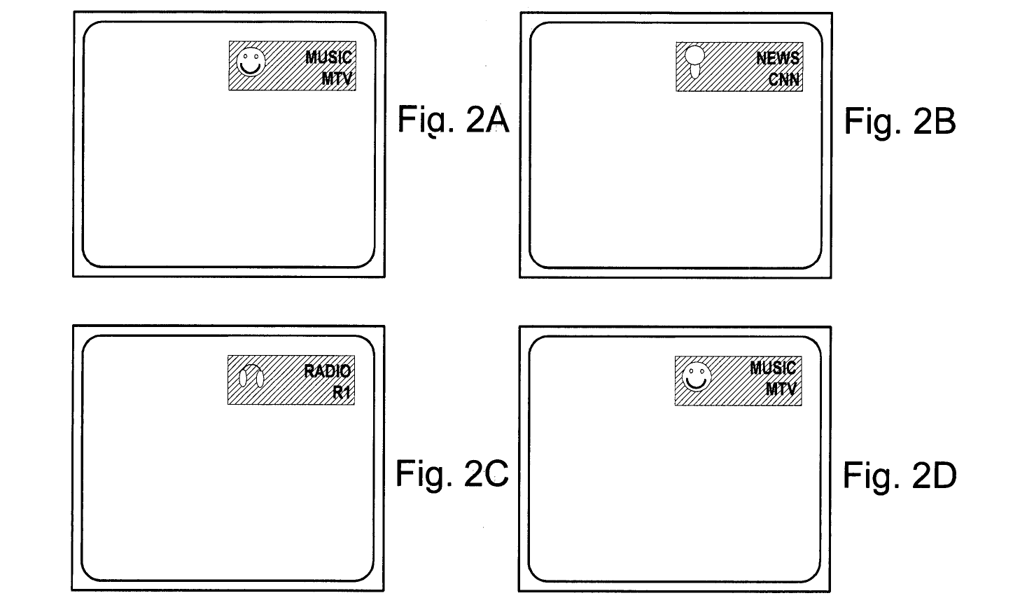

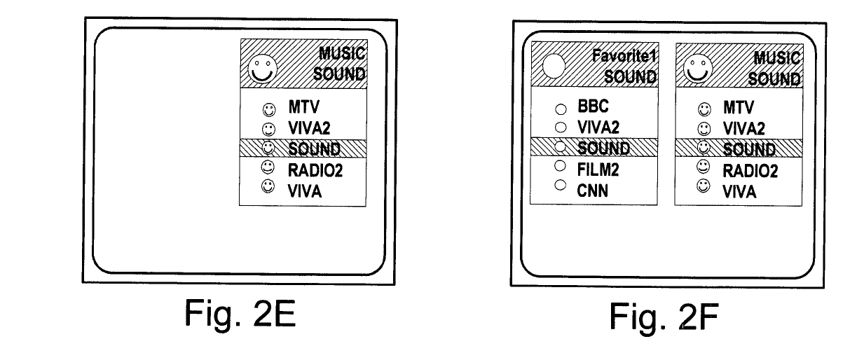

FIG. 1—structure of a digital television decoder, with a lists managing block marked, FIG. 2A, 2B, 2C, 2D, 2E, 2F
exemplary methods of presenting information about the lists and elements on the television display, according to the algorithms, which are presented further on,

FIG. 3—a television remote control unit, with a button separated for fast service of the lists,

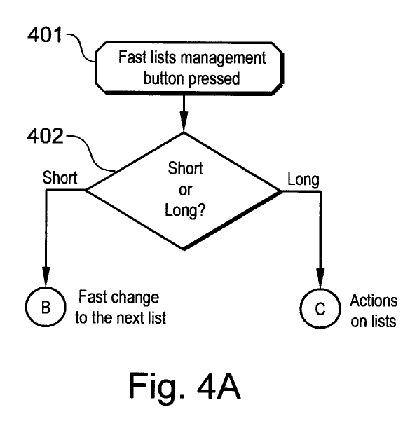

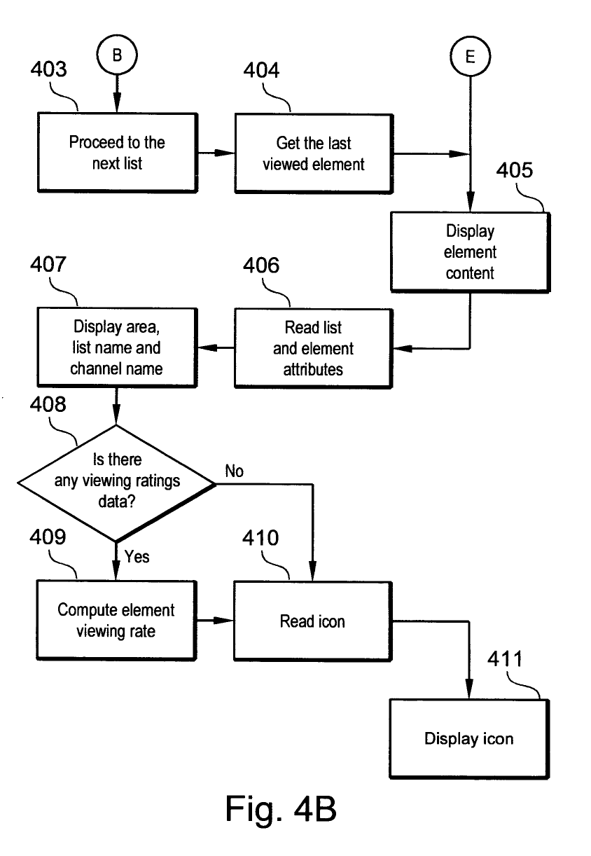

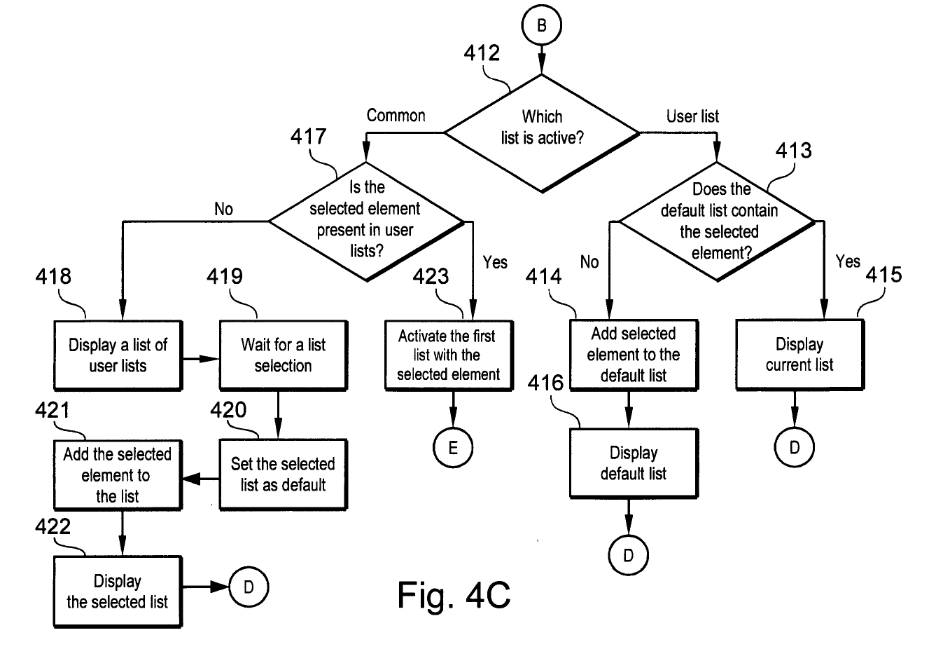

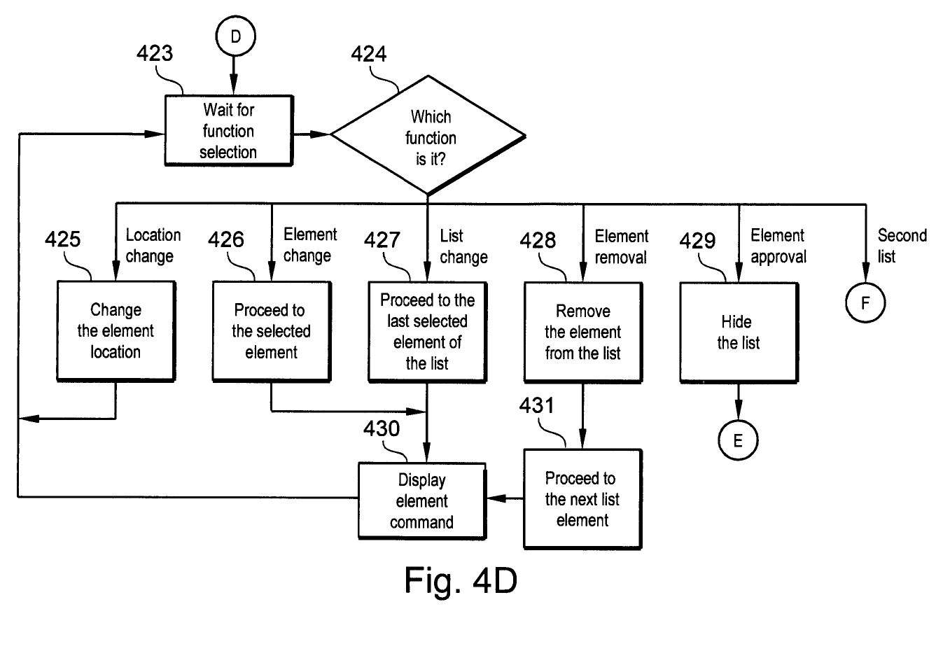

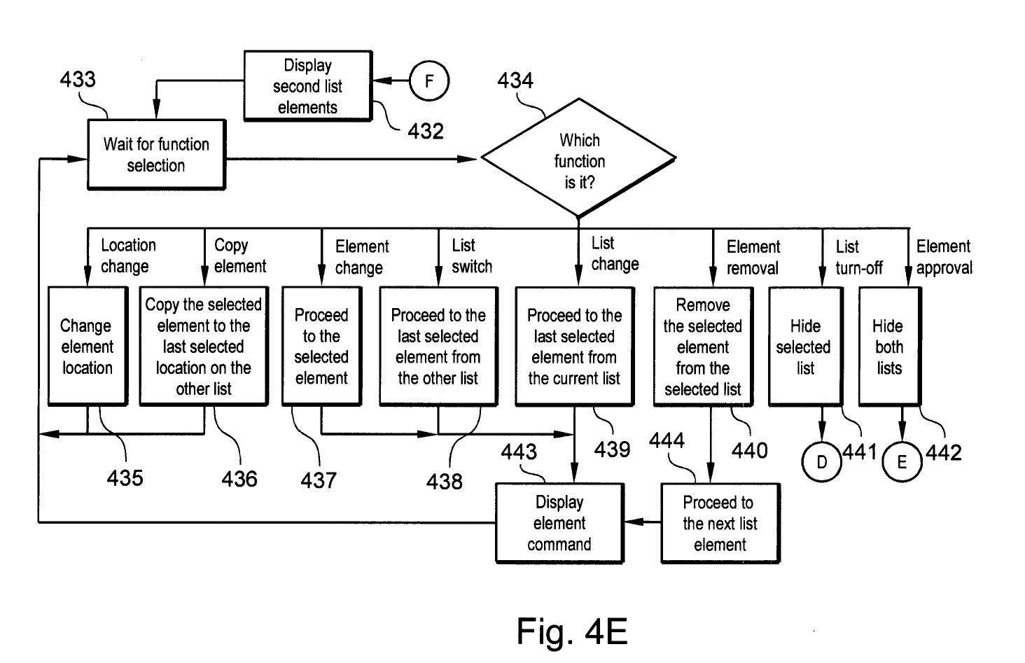

FIG. 4A—a method of handling the button for fast handling of the lists,

FIG. 4B—a procedure of fast transition to the recently viewed element from the next list,

FIG. 4C—a procedure of adding an element to the list,

FIG. 4D—a procedure of handling one list on the screen,

FIG. 4E—a procedure of handling two lists on the screen,

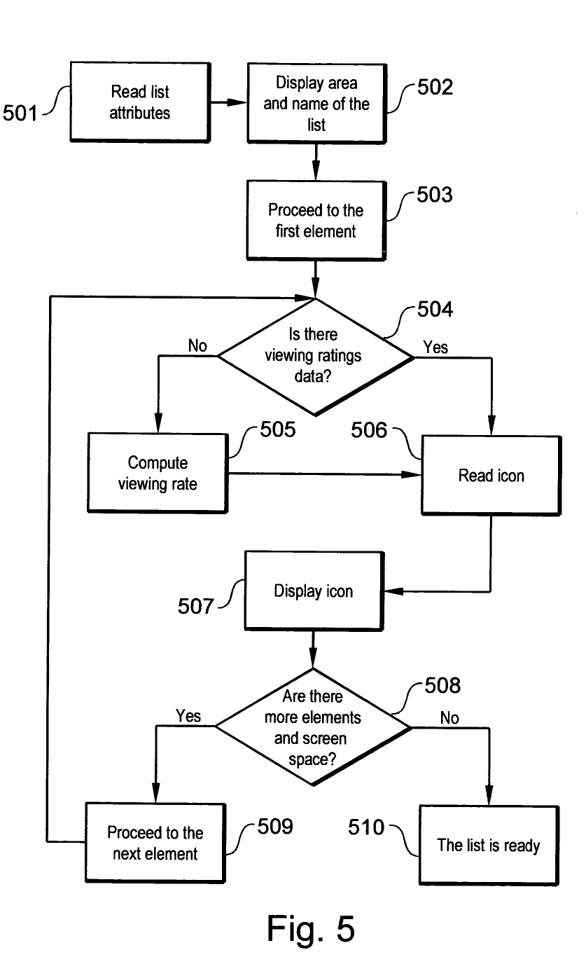

FIG. 5—a method of displaying a list.

After a first short pressing of the list handling button L, the service device DK, which is a decoder of digital television, will start to display the recently selected or the first signal, if recently, on the given day or week the list was not selected, it will start to display the element of the next list coming after the displayed one when the service button L is pressed. In parallel, in a rectangle the following will be displayed; the color, which is assigned to the given list, the name of the list, and the name of the element, displayed on the screen. Moreover, this information is broadened by an icon, which shows a smiling face, informing about the viewing ratings of this element, and next the higher the percent share of the time of watching a given channel, the face's smile is broader. The icon may be the same for all the lists, or different lists may have different types of icons, assigned to them.

So that FIG. 2A illustrates a screen of a television set after the first use of the list service button—MTV channel will turn on from the list MUSIC and the icon, informing about high viewing ratings of this channel. The consecutive use of the list service button will cause a transition to the screen—FIG. 2B, where CNN channel will turn on from the NEWS list—with the viewing ratings given in form of a microphone icon with different size. FIG. 2C illustrates an icon informing about viewing ratings of the first element of the list in form of earphones with different size or different color—channel RADIO1 from the RADIO list of radio channels. Assuming that the system consists of only three lists, the consecutive use of the list service button will cause a transition to FIG. 2D, analogical to FIG. 2A.

The user may add an element to the list, or select a different element from it by pressing longer the list service button L. Then, if the currently viewed element is located on the default list, it will appear on the screen. If it is not present on the default list, it will be added to it or to the list selected by the user. A list of elements of a given list will appear with the currently selected one marked (FIG. 2E), and the user may select another element, remove an element, change the sequence of elements on the list, or turn on a second list in order to copy elements between the lists (FIG. 2F).

Information about the defined lists is stored in the BOK storage of the handling device DK in the chart with a structure, the example of which is given below:

| LIST NO. | NAME | ICON | TYPE |
|---|---|---|---|
| 1 | TV | Sun | General |
| 2 | RADIO | Earphones | General |
| 3 | MUSIC | Face | User's |
| 4 | NEWS | Microphone | User's |
| 5 | INTERNET | Floppy disk | User's |

The column ICON defines the first part of the icon's name, which is assigned to a given list. The column TYPE defines the type of the list. A list of ‘general’ type is a list, which is arranged by the decoder. For example, TV list may include all television channels available in a decoder. RADIO list may include all radio channels. The user has no influence on the content of general lists. However, ‘user lists’ are manually prepared by the user. For example, the MUSIC list can include favorite television, radio channels and/or web sites related to music, selected by the user. The FAVORITE list can consist of favorite channels of the user with a different type. Obviously, this is the user, who gives a name to a list and he decides, which channels it will include.

The BOK storage, stores a variable defining the number of the user's list, which will be treated as a default list. Initially, the default list is the first list of the user. During the operation of the system, the default list will be the one, to which the user has recently added an element. The default list is suggested as the first at adding a program to the list—FIG. 4C.

It has been assumed that a list may include only names or appropriate identifiers of services, arranged in a specific order, or the names of services in association with information about their viewing ratings, for example the number of minutes, during which a given service was viewed in the period of recent week. The exemplary structure of the list may be as follows:

| Position | Service | Viewing ratings (min.) |
|---|---|---|
| 1 | BBC | 50 |
| 2 | News1 | 40 |
| 3 | CNBC | 35 |

The lists may be sorted according to their viewing ratings, but the user may manually change the sequence of the elements in the lists with the type of ‘user list’ at displaying the list, which has been described in FIG. 2D and 2F. The list may have a status of a list arranged according to viewing ratings or manually arranged. By means of selecting the appropriate function, it can be once again sorted according to viewing ratings and it will regain the status of a list arranged according to viewing ratings. This status will cause that the list will be automatically sorted, after each change of viewing ratings of any of the channels.

For activating functions related to the lists, an additional button of the remote control unit L is used. The method of operating it is illustrated in FIG. 4A. If it is pressed in a short time—a procedure of quick transition to the next list will be started—FIG. 4B. If it is pressed in a longer time, for example longer than 2 seconds—a procedure enabling operations on the lists will be executed—FIG. 4C.

In the first step—FIG. 4B—the procedure comes to the next list. Next, it reads the element, which was recently selected from this list or the first element, if the list was not used recently, for example in the present day or week. It displays the content of the element, i.e. the defined service: a television, radio channel, a DVD film, a web site etc. In the further part, it prepares and displays information about the element. It reads the attributes of the list, i.e. the color of the background of the area displaying information and the type of the icon and the element i.e. the viewing ratings. Next, it displays the rectangle like area attributing a color to it, as it is defined to a given list, and the names of the list and the element in it. It checks if the data are available about the viewing ratings of the given element—if so, it computes the percentage of viewing ratings in relation to other elements, based on the following formula:
% of element's viewing ratings=viewing ratings of element/viewing ratings of all elements of the list

Next, it reads appropriate icon from BOK storage—if the viewing ratings was computed, it selects the icon according to viewing ratings, if not—it selects the first of the icons of the type defined for the list. The last step is to display the icon close by the name of the list and the element.

When the user presses the button L of the remote controller longer (FIG. 4C), the system understands it as a wish to display other elements of the currently active list, or to add an element to one of the lists. First, the procedure checks what type of the list is currently active. If this is a general list, the procedure checks—stating with the default list—if the currently selected element is on the user's lists. If so, the first list containing this element is activated, and next a short information is displayed about the selected list and the element—starting from step E of procedure in FIG. 4B. If none of the user lists contains the selected element, the procedure presents the user with a list of the user lists, first presenting the default list. The user selects the list, to which he would like to add the selected element. The selected list receives a status of a default list. Next the element is added to the last or the first item of this list, depending on how the system is designed), and next this list is displayed on the screen—the display of the content of the lists is implemented by procedure from FIG. 5. After displaying the list, the user can take actions on this list. Such actions are illustrated in FIG. 4D. If the active list is the user list, the procedure checks, if the default list currently contains the selected element. If so, the content of the currently selected list will be displayed on the screen. After displaying the list, the user can take actions illustrated in FIG. 4D on this list, for example, he can remove an element off the list this time. If the default list does not contain this element, it will be added to the last or the first item of the default list, depending on how the system will be designed, and next the default list will be displayed on the screen. After displaying the list the user can take actions, illustrated in FIG. 4D, on this list, for example he can move an element to another list.

Such method of work allows for an easy and intuitive management of the list content. Most of all, it enables fast adding of the elements to the default list and fast access granted to the list of elements on a specific list.

The most frequently encountered device, which services DK is a digital television decoder. The structure of the decoder with the marked blocks, valid for the described solution is illustrated in FIG. 1.
external signals handling block is used for supervising transmission of signals—here are the elements (like tuners, demodulators) which allow to select a source of data, required by the user (for example a channel from cable television signal).
Signal processing block is used for processing the received signal (for example decoding an MPEG stream of television signal) and controlling the external signals handling block (for example the command to switch to appropriate channel).

It also incorporates OSD system (Eng. On-Screen Display), which is used for generating graphics and overlaying it on the output signal.
audio-video block generates a signal accepted by external receiver, for example, an analogue television set which supports PAL signal.
Block of handling channels with BOK storage incorporates different blocks, which facilitate moving in the services. It can be, for example, a block of a channels guide, which presents the users information on the subject of available channels and programs broadcasted on them. Here also the lists handling block is located—the functionality of which will be described hereunder.
RCU interface (Eng. Remote Control Unit)—a system for handling the remote control interface for communication with RCU. A similar interface is located in the RCU.
RCU—incorporates an interface for communication and a keyboard, by means of which the user gives commands.

The procedure of handling the list, displayed on the screen is illustrated by FIG. 4D. The whole process is controlled by the user, by selecting appropriate function. Various buttons of the remote controller as well as appropriately designed on-screen menu can be used for selections of functions. The user has a choice of the following functions:
change the element's position—changes the position of a selected element on the list, for example by means of arrows moves it one position to the top or to the bottom,
change the element—selects different element, for example by means of arrows selects the next or previous element, or chooses an element with a specific number; next a command is given to display the content of the element to the systems of the receiving and signal processing block, and the procedure awaits the next function of the user,
change the list—selects another list, for example, by means of arrows selects the next or the previous list, and after switching to the list it displays its recently or first selected element,
remove the element—removes the currently selected element, and next displays the element, which comes after it,
accept the element—turns off the list display and moves to the procedure described in FIG. 4B, starting with step E,
second list—displays the second list, based on the procedure from FIG. 4E.

FIG. 4E presents a procedure for handling two lists. In step one, on the opposite side of the screen the second list is displayed, which is the next list after the one, which has already been displayed on the screen. For the selection of function, one can use various buttons of the remote controller and appropriately designed on-screen menu. These functions are analogical to the ones presented in FIG. 4E, with the following function added:
copy the element—the selected element will be copied to the recently selected item on the second list,
switch the list—the cursor will be moved to the second list, to the place of the element, which was recently selected on it,
turn off the list—display of the currently selected or second list is stopped, so that there is only one list on the screen; the further method of handling this list proceeds according to FIG. 4D,
accept the element—display of both lists is stopped, and the procedure comes to the procedure described in FIG. 4B, starting with step E.

FIG. 5 illustrates the method of displaying a list. The display starts with the first element on the list. If viewing ratings data are available for this element, the percentage viewing ratings is calculated for it. Next, the appropriate icon is read and displayed by the side of the element, as in FIG. 2e. Next, it is being checked, if there are still undisplayed elements and if there is still space on the list—if so, the procedure comes to the next element.

Each list can have a certain type of icon assigned to it (each type has a few similar icons), which will inform about the viewing ratings of programs on this list. The user has a choice of icons installed in the system, he can also create (draw) his/her own icons, if there is a graphical program available in the decoder. For example, in order to illustrate the viewing ratings of elements in the musical list, one can use the icon in the shape of a saxophone with different coloring. For the list of messages—a different size of microphone. For the radio list—a different size of earphones. The icons are recorded as files. The name of a file can contain the icon type (for example a microphone) and a minimum percent share of the viewing ratings of a given element, for which this icon will be selected (for example 60=60% share). So that an example of the file name will be ‘microphone 60.bmp’.

Summing up the essential features of the method:
additional button on the remote control unit—fast handling of lists—L, which can be an additional button, or take over the functionality of the previous button for handling lists (it is often being marked as FAV);
a short pressing of the button of fast handling of lists causes that immediately the first element is displayed from the next list with a short information about it;
a long pressing of the lists fast handling button causes that:
   if the general list is active and the element is not present on the user lists—adding an element (to the beginning or the end) to the list selected by the user (this list obtains the status of a default list), and next the content of this list is displayed,
   if the general list is active and the element is on one of the user lists—switching to the user list, on which this element is located and giving short information about the active list and the element,
   if the user list is active and the element is not present on the default list—display the currently active list content,
information on a given list are displayed in a rectangle with a shade assigned to the given list;
an icon is displayed by the name of the element, which presents viewing ratings of the element in relation to other elements of the list;
different types of icons can be assigned to different lists.

1. The method of access and handling service lists, set up earlier from such services as television and radio channels, DVD libraries, web sites, as well as user services, available in a handling device equipped at least with the functions of a decoder of digital television, while the service lists are general lists, set up by the decoder and preference lists, set up by the user, characterized in that after selecting the function of moving to the next list an identifier is fetched from storage (BOK) of the handling device (DK): of the service that has been recently viewed on the list, which is next after the one displayed during selection of this function or the first from the next list, and the handling device (DK) is set to receive this service, with parallel display, on the screen of television set, of information about the assignment of the service to the list and its viewing ratings, and next, in the consecutive steps, a transition to the next lists occurs, while in case of defining a specific list, after selecting a function of choosing another element from this lit, at least one list of services available on this list is fetched from the storage (BOK) of the handling device (DK), and next after defining the viewing ratings for each service of this list, a list of services is displayed together with information about the assignment of this list and viewing ratings.

2. The method according to claim 1, characterized in that at least two lists of services available in the storage are fetched from the storage (BOK) of the handling device (DK), and next, after defining separate lists of its viewing ratings for each element, the lists of services are displayed together with information about their affiliation to the list and viewing ratings, and next using the total content of the displayed lists, the content of separate lists is modified.

3. The method according to claim 1, characterized in that the viewing ratings of the service is defined as a percentage ratio between its viewing ratings and the viewing ratings of selected services of the fetched list.

4. The method according to claim 1, characterized in that as well the choice of moving to the next list as the choice of the service from the currently active list, and also modification of the content of separate lists is made directly by means of dedicated buttons of the remote control unit (U).

5. The method according to claim 1, characterized in that the displayed information about the affiliation to the list and viewing ratings of a selected element is assigned to graphical symbols.

6. The method according to claim 5, characterized in that graphical symbols are assigned in form of genre icons.

7. The method according to the claim 1, characterized in that making a selection of the function of adding the currently viewed service to the list, in case this service appears already on one of the inactive preference lists, while this list is activated in case when the viewed service does not appear on any of the inactive preference lists, the service is added to the selected preference list.

8. The method according to claim 7, characterized in that in case of selecting a preference list as the first one, a default list is presented, which is the list to which an element was added recently.
